(19) United States
(12) Patent Application Publication
(10) Pub. No.: US 2024/0111663 A1
(43) Pub. Date: Apr. 4, 2024

(54) Electronic system and firmware update method having firmware update troubleshooting mechanism

(71) Applicant: REALTEK SEMICONDUCTOR CORPORATION, Hsinchu (TW)

(72) Inventors: CHUN-HAO PENG, Hsinchu (TW); TSUNG-PENG CHUANG, Hsinchu (TW)

(21) Appl. No.: 18/372,717

(22) Filed: Sep. 26, 2023

(30) Foreign Application Priority Data
Sep. 30, 2022 (TW) 111137363

(51) Int. Cl. G06F 11/36

(52) U.S. Cl. CPC G06F 11/3684; G06F 11/3688; G06F 11/3692

(57) ABSTRACT

The present disclosure discloses a firmware update method having firmware update troubleshooting mechanism. Partial data included in firmware data is used as test data to perform a test process to write the test data to a firmware storage terminal by using a control interface of a processing terminal according to the setting of access parameters, read the written test data from the firmware storage terminal through the control interface and compare the written test data and the test data to generate a comparison result. A parameter adjustment process is performed when the comparison result indicates a mismatching condition such that the test process is performed again and the parameter adjustment process is further performed. When the comparison result indicates a matching condition, the firmware data is transmitted to the processing terminal and is written to the firmware storage terminal by using the control interface.

### BACKGROUND OF THE INVENTION

### 1. Field of the Invention

The present disclosure relates to an electronic system and a firmware update method thereof having firmware update troubleshooting mechanism.

### 2. Description of Related Art

During the activation of a processor, firmware data is read from an external storage device through a control interface to operate the firmware data so as to execute the subsequent activation process.

However, when defects of either the bad circuit design of the printed circuit board, the impedance mismatch of the layout or the manufacturing process deviation that affects the electrical characteristic of the signals of the control interface exist, the control interface may not access the data in the external storage device correctly. When the activation process is executed by the processor according to the firmware data with errors, the activation process may fail to proceed such that the processor can not operate normally and can not further execute any application program.

### SUMMARY OF THE INVENTION

In consideration of the problem of the prior art, an object of the present disclosure is to provide an electronic system and a firmware update method thereof having firmware update troubleshooting mechanism.

The present invention discloses a firmware update method having firmware update troubleshooting mechanism used in an electronic system that includes steps outlined below. Partial data included in firmware data is used as test data to perform a test process by a control terminal to transmit the test data to a processing terminal, so as to write the test data to a firmware storage terminal by using a control interface of the processing terminal according to a setting of a plurality of access parameters, read the written test data from the firmware storage terminal through the control interface and compare the written test data and the test data to generate a comparison result. A parameter adjustment process is performed on at least one of the access parameters by the control terminal when the comparison result indicates a mismatching condition. The test process is performed by using the partial data again by the control terminal after the parameter adjustment process finishes being performed, such that the parameter adjustment process is further performed again when the comparison result still indicates the mismatching condition. The firmware data is transmitted to the processing terminal by the control terminal when the comparison result indicates a matching condition, so as to write the firmware data to the firmware storage terminal by using the control interface according to the setting of the access parameters adjusted by the parameter adjustment process.

The present invention also discloses an electronic system having firmware update troubleshooting mechanism that includes a firmware storage terminal, a processing terminal including a control interface and a control terminal. The control terminal is configured to execute a burning program, to further execute a firmware update method that includes steps outlined below. Partial data included in firmware data is used as test data to perform a test process by the control terminal to transmit the test data to the processing terminal, so as to write the test data to the firmware storage terminal by using the control interface of the processing terminal according to a setting of a plurality of access parameters, read the written test data from the firmware storage terminal through the control interface and compare the written test data and the test data to generate a comparison result. A parameter adjustment process is performed on at least one of the access parameters by the control terminal when the comparison result indicates a mismatching condition. Test process is performed by using the partial data again by the control terminal after the parameter adjustment process finishes being performed, such that the parameter adjustment process is further performed again when the comparison result still indicates the mismatching condition. The firmware data is transmitted to the processing terminal by the control terminal when the comparison result indicates a matching condition, so as to write the firmware data to the firmware storage terminal by using the control interface according to the setting of the access parameters adjusted by the parameter adjustment process.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of an electronic system having firmware update troubleshooting mechanism according to an embodiment of the present invention.

FIG. 2 illustrates a firmware update method having firmware update troubleshooting mechanism according to an embodiment of the present invention.

FIG. 3 illustrates a flow chart of a test process according to an embodiment of the present invention.

FIG. 4 illustrates a flow chart of a firmware update method according to another embodiment of the present invention.

FIG. 5 illustrates a flow chart of an activation process performed by processing terminal according to an embodiment of the present invention.

### DETAILED DESCRIPTION OF THE PREFERRED EMBODIMENTS

An aspect of the present invention is to provide an electronic system and a firmware update method thereof having firmware update troubleshooting mechanism to perform test on the processing terminal and the firmware storage terminal disposed on circuit boards having different qualities to obtain the optimal access parameters so as to increase the accuracy of the firmware data stored by the firmware storage terminal. The processing terminal is therefore able to read the correct firmware data from the firmware storage terminal.

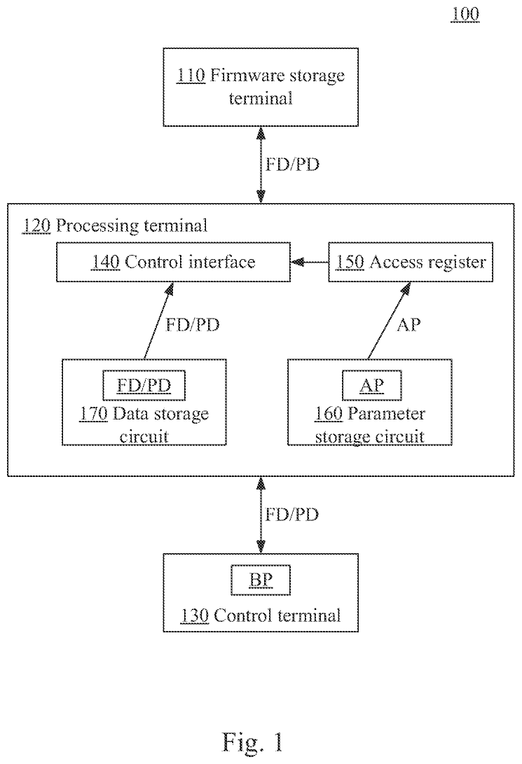

Reference is now made to FIG. 1. FIG. 1 illustrates a block diagram of an electronic system 100 having firmware update troubleshooting mechanism according to an embodiment of the present invention. The electronic system 100 includes a firmware storage terminal 110, a processing terminal 120 and a control terminal 130.

The firmware storage terminal 110 is such as, but not limited to a flash memory or an erasable programmable read only memory (EPROM), and is configured to perform data storage related to the firmware.

The processing terminal 120 and the firmware storage terminal 110 can be formed on the same printed circuit board and integrated into one electronic apparatus. The processing terminal 120 includes a control interface 140, an access register 150, a parameter storage circuit 160 and a data storage circuit 170.

The control interface 140 is such as, but not limited to a serial peripheral interface (SPI) or an I²C interface, and is configured to access the firmware storage terminal 110.

The access register 150 is related to the control interface 140 and is configured to configure the control interface 140 to access the firmware storage terminal 110. More specifically, the processing terminal 120 writes the access parameters AP to the access register 150, so as to configure the control interface 140 such that the control interface 140 accesses the firmware storage terminal 110 accordingly.

The access parameters AP are used to configure the access ability of the control interface 140. In an embodiment, the access parameters AP includes such as, but not limited to a slew rate, a driving ability and a clock frequency. The slew rate is a slope of a voltage increasing amount of an electrical signal generated by the control interface 140 verses time. The driving ability is a current amount of the electrical signal generated by the control interface 140. The clock frequency is the frequency that the control interface 140 operates accordingly to generate the electrical signal.

It is appreciated that in the embodiment described above, the number of the access register 150 is illustrated to be one in FIG. 1. However, the number of the access register 150 can be different based on different numbers of the access parameters AP in practical applications. Further, the numbers and the types of the access parameters AP can also be different according to practical requirements. The present invention is not limited thereto.

The parameter storage circuit 160 is configured to store the access parameters AP so as to be read by the processing terminal 120 and further written to the access register 150 to configure the control interface 140. In an embodiment, the parameter storage circuit 160 is a one-time programming memory (OTP ROM) or an eFuse.

The data storage circuit 170 is configured to store the data that is supposed to be written to the firmware storage terminal 110 by the control interface 140. More specifically, the data storage circuit 170 is configured to store firmware related data so as to be written the firmware storage terminal 110 by the processing terminal 120 through the control interface 140. In an embodiment, the data storage circuit 170 is a random access memory (RAM).

It is appreciated that the processing terminal 120 may further includes a processing circuit, a data bus or other components (not illustrated in the figure) that is configured to control, coordinate or perform data transmission among the circuits described above. According to the control of these components, the processing terminal 120 can manage the control interface 140, the access register 150, the parameter storage circuit 160 and the data storage circuit 170 to perform the operations described below.

The control terminal 130 is configured to execute a burning program BP to control the processing terminal 120 and perform firmware update on the firmware storage terminal 110 through the control interface 140. In an embodiment, the control terminal 130 can be an operation system operated in a remote electronic apparatus (not illustrated in the figure) that is independent from the processing terminal 120 and the firmware storage terminal 110, or can be an operation system operated in the processor of the processing terminal 120 to execute the burning program BP. The present invention is not limited thereto.

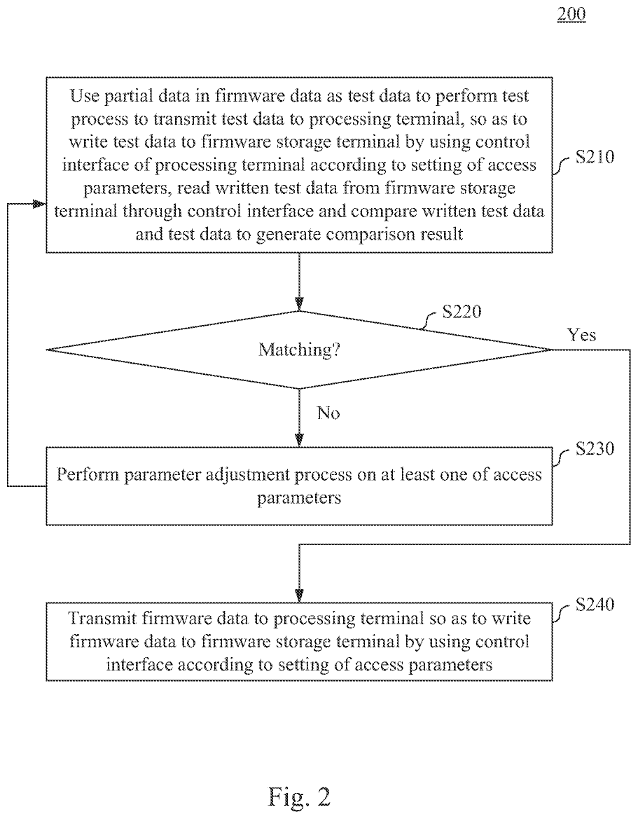

Reference is now made to FIG. 2 at the same time. FIG. 2 illustrates a firmware update method 200 having firmware update troubleshooting mechanism according to an embodiment of the present invention.

Besides the apparatus described above, the present invention further discloses the firmware update method 200 that can be used in such as, but not limited to the electronic system 100 illustrated in FIG. 1. More specifically, the control terminal 130 can execute the firmware update method 200 by executing the burning program BP so as to perform firmware update on the firmware storage terminal 110 through the processing terminal 120. An embodiment of the firmware update method 200 is illustrated in FIG. 2 and includes the steps outlined below.

In step S210, partial data PD included in firmware data FD is used as test data to perform a test process by the control terminal 130 to transmit the test data to the processing terminal 120, so as to write the test data to the firmware storage terminal 110 by using the control interface 140 of the processing terminal 120 according to a setting of the access parameters AP, read the written test data from the firmware storage terminal 110 through the control interface 140 and compare the written test data and the test data to generate a comparison result.

The partial data PD is a part of the firmware data FD. In an embodiment, the size of the partial data PD can be such as, but not limited to 4 kilobytes (KB). However, the present invention is not limited thereto.

In an embodiment, the control terminal 130 uses predetermined values of the access parameters AP to configure the control interface 140 to access the firmware storage terminal 110 when the test process is performed for the first time. For example, according to the predetermined values of the access parameters AP, the control terminal 130 sets the slew rate to be a maximum slew rate, the driving ability to be a minimum driving ability and the clock frequency to be a maximum clock frequency such that the control interface 140 accesses the firmware storage terminal 110 accordingly.

The performance of the test process is described in detail in the following paragraphs.

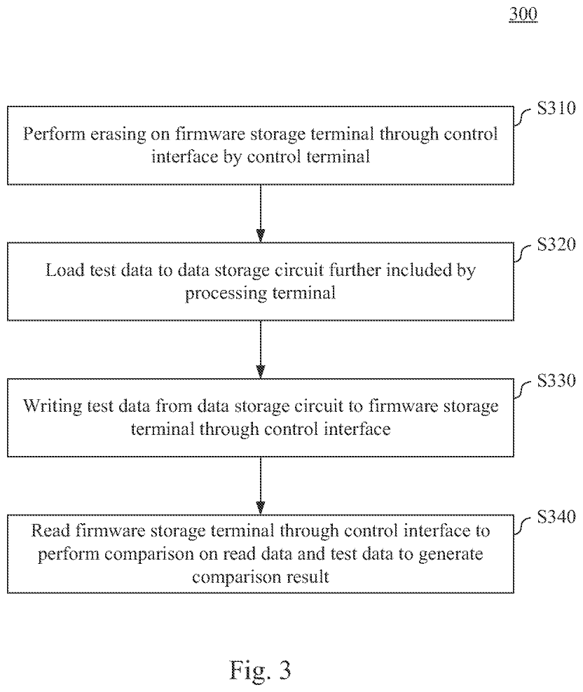

Reference is now made to FIG. 3 at the same time. FIG. 3 illustrates a flow chart of a test process 300 according to an embodiment of the present invention. An embodiment of the test process 300 is illustrated in FIG. 3 and includes the steps outlined below.

In step S310, erasing is performed on the firmware storage terminal 110 through the control interface 140 by the control terminal 130.

In step S320, the test data is loaded to the data storage circuit 170 further included by the processing terminal 120 by the control terminal 130. In an embodiment, the control terminal 130 may load the test data to the data storage circuit 170 of the processing terminal 120 through a wired channel (e.g., universal serial bus) or a wireless channel (e.g., Bluetooth or WiFi).

In step S330, the test data is written from the data storage circuit 170 to the firmware storage terminal 110 through the control interface 140 by the control terminal 130.

In step S340, the firmware storage terminal 110 is read through the control interface 140 to perform comparison on read data and the test data to generate the comparison result by the control terminal 130.

After the test process finishes, the flow in FIG. 2 keeps performing the following steps.

In step S220, whether the comparison result indicates a matching condition is determined by the control terminal 130.

In step S230, a parameter adjustment process is performed on at least one of the access parameters AP by the control terminal 130 when the comparison result indicates a mismatching condition.

In an embodiment, the control terminal 130 performs at least one of decreasing the slew rate, increasing the driving ability and decreasing the clock frequency during the parameter adjustment process.

After the parameter adjustment process finishes being performed, the control terminal 130 performs the test process by using the partial data PD again. As a result, the flow goes back to step S210 to perform the test process and perform comparison in step S220. The parameter adjustment process is further performed again in S230 when the comparison result still indicates the mismatching condition.

In an embodiment, in different loops of performance of the parameter adjustment process, the control terminal 130 in turn adjusts each of the access parameters AP step by step.

For example, in different loops of performance of the parameter adjustment process, the control terminal 130 decreases the slew rate step by step first until the slew rate reaches the minimum slew rate. The control terminal 130 increases the driving ability step by step subsequently until the driving ability reaches a maximum driving ability. The control terminal 130 further decreases the clock frequency step by step until the clock frequency reaches a minimum clock frequency. However, in other embodiments, the control terminal 130 may also adjust more than one access parameters simultaneously or set different adjustment steps for the access parameters. The present invention is not limited thereto.

In step S240, the firmware data FD is transmitted to the processing terminal 120 by the control terminal 130 when the comparison result indicates the matching condition, so as to write the firmware data FD to the firmware storage terminal 110 by using the control interface 140 according to the setting of the access parameters AP adjusted by the parameter adjustment process.

In an embodiment, the control terminal 130 may finish the burning process once the firmware data FD is written to the firmware storage terminal 110. However, in order to make sure the correctness of the firmware data FD, the control terminal 130 may selectively use the firmware data FD as the test data to perform the test process illustrated in FIG. 3, so as to write the firmware data FD to the firmware storage terminal 110 according to the adjusted access parameters AR. The control terminal 130 further reads data from the firmware storage terminal 110 and compares the read data and the test data to generate a firmware comparison result.

The control terminal 130 performs the parameter adjustment process on at least one of the access parameters AP when the firmware comparison result indicates the mismatching condition. The control terminal 130 further performs the test process by using the firmware data FD again, such that the parameter adjustment process is further performed again when the firmware comparison result still indicates the mismatching condition.

In an embodiment, when the slew rate reaches the minimum slew rate, the driving ability reaches the maximum driving ability and the clock frequency reaches the minimum clock frequency, the control terminal 130 determines that the access parameters are not able to be further adjusted. Under such a condition, the control terminal 130 further determines that the firmware data FD fails to be updated to the firmware storage terminal 110. More specifically, when the access parameters AP are not able to be further adjusted, the control terminal 130 determines that the firmware data FD fails to be updated to the firmware storage terminal 110 due to either the bad circuit design of the printed circuit board, the impedance mismatch of the layout or the manufacturing process deviation that affects the electrical characteristic of the signals.

On the other hand, the control terminal 130 stores the access parameters to a parameter storage circuit 160 further included in the processing terminal 120 when the firmware comparison result indicates the matching condition. When the processing terminal 120 performs an activation process of an electronic apparatus that includes the processing terminal 120, the processing terminal 120 reads the access parameters AP from the parameter storage circuit 160, configures the control interface 140 and further reads the firmware data FD from the firmware storage terminal 110 according to the access parameters AP through the control interface 140 to further perform the subsequent activation process.

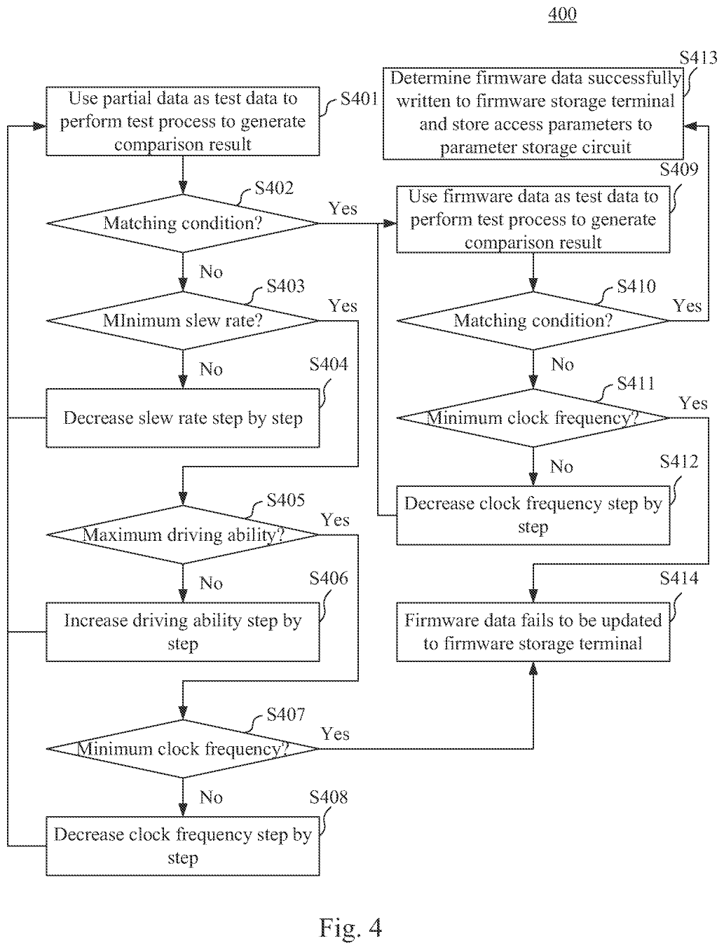

Reference is now made to FIG. 4. FIG. 4 illustrates a flow chart of a firmware update method 400 according to another embodiment of the present invention. The firmware update method 400 includes details steps for executing the firmware update method 200 in a usage scenario and subsequent steps to guarantee the correctness of the firmware data FD. An embodiment of the firmware update method 400 is illustrated in FIG. 4 and includes the steps outlined below.

In step S401, the partial data PD included in the firmware data FD is used as the test data to perform the test process by the control terminal 130 to transmit the test data to the processing terminal 120, so as to write the test data to the firmware storage terminal 110 by using the control interface 140 of the processing terminal 120 according to the setting of the access parameters AP, read the written test data from the firmware storage terminal 110 through the control interface 140 and compare the written test data and the test data to generate a comparison result.

As described above, the control terminal 130 sets the slew rate to be the maximum slew rate, the driving ability to be the minimum driving ability and the clock frequency to be the maximum clock frequency when the test process is performed for the first time such that the control interface 140 access the firmware storage terminal 110 accordingly.

In step S402, whether the comparison result indicates the matching condition is determined by the control terminal 130.

In step S403, whether the slew rate reaches the minimum slew rate is determined by the control terminal 130 when the comparison result indicates the mismatching condition.

In step S404, the slew rate is decreased step by step by the control terminal 130 when the slew rate does not reach the minimum slew rate. The amount of adjustment of the slew rate can be set to be a fixed value for every step or be different values for every step.

The flow goes back to step S401 to perform test process again to generate the comparison result such that whether the comparison result indicates the matching condition is further determined in step S402. When the comparison result still indicates the mismatching condition and the slew rate does not reach the minimum slew rate, the flow repeats steps S401-S404 until the slew rate reaches the minimum slew rate.

In step S405, whether the driving ability reaches the maximum driving ability is determined by the control terminal 130 when the slew rate reaches the minimum slew rate.

In step S406, the driving ability is increased step by step by the control terminal 130 when the driving ability does not reach the maximum driving ability. The amount of adjustment of the driving ability can be set to be a fixed value for every step or be different values for every step.

The flow goes back to step S401 to perform test process again to generate the comparison result such that whether the comparison result indicates the matching condition is further determined in step S402. When the comparison result still indicates the mismatching condition and the driving ability does not reach the maximum driving ability, the flow repeats steps S401-S403 and S405-S406 until the driving ability reaches the maximum driving ability.

In step S407, whether the clock frequency reaches the minimum clock frequency is determined by the control terminal 130 when the driving ability reaches the maximum driving ability.

In step S408, the clock frequency is decreased step by step by the control terminal 130 when the clock frequency does not reach the minimum clock frequency. The amount of adjustment of the clock frequency can be set to be a fixed value for every step or be different values for every step.

The flow goes back to step S401 to perform test process again to generate the comparison result such that whether the comparison result indicates the matching condition is further determined in step S402. When the comparison result still indicates the mismatching condition and the clock frequency does not reach the minimum clock frequency, the flow repeats steps S401-S403, S405 and S407-S408 until the clock frequency reaches the minimum clock frequency.

In step S409, the firmware data FD is used as the test data to perform the test process by the control terminal 130 when the comparison result indicates the matching condition, so as to write the firmware data FD to the firmware storage terminal 110, read the written firmware data FD from the firmware storage terminal 110 through the control interface 140 and compare the read data and the test data to generate the firmware comparison result.

Under such a condition, the firmware data FD is written to the firmware storage terminal 110 by the control terminal 130 according to the access parameters AP that allow the partial data PD to be correctly accessed from the firmware storage terminal 110 through the control interface 140.

In step S410, whether the firmware comparison result indicates the matching condition is determined by the control terminal 130.

In step S411, whether the clock frequency reaches the minimum clock frequency is determined by the control terminal 130 when the firmware comparison result indicates the mismatching condition.

In step S412, the clock frequency is decreased step by step by the control terminal 130 when the clock frequency does not reach the minimum clock frequency.

The flow goes back to step S409 to perform test process again to generate the firmware comparison result such that whether the firmware comparison result indicates the matching condition is further determined in step S410. When the firmware comparison result still indicates the mismatching condition and the clock frequency does not reach the minimum clock frequency, the flow repeats steps S409-S412 until the clock frequency reaches the minimum clock frequency.

In step S413, the firmware data FD is determined to be successfully written to the firmware storage terminal 110 by the control terminal 130 when the comparison result is determined to indicates the matching condition in step S410, such that the access parameters AP is stored to the parameter storage circuit 160 further included in the processing terminal 120 by the control terminal 130.

In step S414, the access parameters AP are determined to not able to be further adjusted by the control terminal 130 when the clock frequency is determined to reach the minimum clock frequency in either step S407 or step S411, such that the firmware data FD is determined to fail to be updated to the firmware storage terminal 110 by the control terminal 130.

It is appreciated that in the present embodiment, the parameter adjustment process may only adjust the clock frequency when the firmware comparison result generated by the test process in S409 indicates the mismatching condition. However, in other embodiments, the parameter adjustment process may adjust other access parameters. The present invention is not limited thereto.

In an embodiment, after the flow described above finishes being performed, the control terminal 130 may further analyze the execution of test process and the parameter adjustment process to figure out the defects of the printed circuit boards.

For example, when the comparison result generated by the test process can be improved by decreasing the slew rate, the issues of overshoot or undershoot of the electrical signals transmitted in the printed circuit board may be confirmed after the correctness of the data is verified. Further, the impedance mismatch of the data transmission paths on the printed circuit board that the control interface 140 uses to transmit data may be discovered as well.

On the other hand, when the comparison result generated by the test process can be improved by increasing the driving ability, the issues of the lengthy rising time and the lengthy falling time of the electrical signals transmitted in the printed circuit board may be confirmed after the correctness of the data is verified, in which such issues affect the setup time and hold time of the signals and may result in error in the retrieved data. Further, the excessive parasitic effect of the equivalent resistors or the equivalent capacitors of the data transmission paths on the printed circuit board that the control interface 140 uses to transmit data may be discovered as well, in which the excessive parasitic effect may introduce the transmission latency.

By using the analysis described above, the subsequent design of the printed circuit board can be improved by addressing the issues described above.

In an embodiment, after either the firmware update method 200 in FIG. 2 or the firmware update method 400 in FIG. 4 finishes being performed, the processing terminal 120 performs the activation process of an electronic apparatus that includes the processing terminal 120. More specifically, the control terminal 130 stores the adjusted access parameters AP to the parameter storage circuit 160 further included in the processing terminal 120. The processing terminal 120 may execute the activation process to read the access parameters AP from the parameter storage circuit 160, configure the control interface 140 and further read the firmware data FD from the firmware storage terminal 110 according to the access parameters AP through the control interface 140 to further perform the subsequent activation process. The subsequent activation process is performed by executing the firmware data FD.

The activation process performed by the processing terminal 120 is described in detail in the following paragraphs.

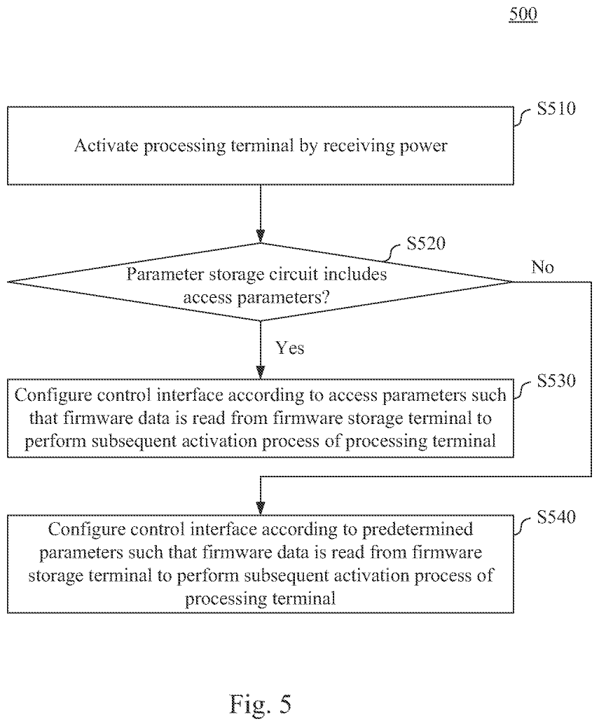

Reference is now made to FIG. 5. FIG. 5 illustrates a flow chart of an activation process 500 performed by processing terminal 120 according to an embodiment of the present invention. An embodiment of the activation process 500 is illustrated in FIG. 5 and includes the steps outlined below.

In step S510, the processing terminal 120 is activated by receiving power.

In step S520, whether the parameter storage circuit 160 includes the access parameters AP is determined.

In step S530, the control interface 140 is configured according to the access parameters AP by the processing terminal 120 when the parameter storage circuit 160 includes the access parameters AP such that the firmware data FD is read from the firmware storage terminal 110 to perform the subsequent activation process of the processing terminal 120 accordingly.

In step S540, the control interface 140 is configured according to predetermined parameters (not illustrated in the figure) by the processing terminal 120 when the parameter storage circuit 160 does not include the access parameters AP such that the firmware data FD is read from the firmware storage terminal 110 to perform the subsequent activation process of the processing terminal 120 accordingly.

In the embodiments described above, the configuration that the parameter storage circuit 160 is disposed in the processing terminal 120 is used as an example. However, in other embodiments, the parameter storage circuit 160 may be configured to be a part of the firmware storage terminal 110 instead of in the processing terminal 120. Under such a condition,
the processing terminal 120 needs to read the access parameters AP from the parameter storage circuit 160 in the firmware storage terminal 110 to configure the control interface 140 first and read the firmware data FD from the firmware storage terminal 110 according to the access parameters AP subsequently to perform the activation process of the processing terminal 120 accordingly.

It is appreciated that the embodiments described above are merely an example. In other embodiments, it is appreciated that many modifications and changes may be made by those of ordinary skill in the art without departing, from the spirit of the invention.

In summary, the electronic system and the firmware update method thereof having firmware update troubleshooting mechanism perform test on the processing terminal and the firmware storage terminal disposed on circuit boards having different qualities to obtain the optimal access parameters so as to increase the accuracy of the firmware data stored by the firmware storage terminal. The processing terminal is therefore able to read the correct firmware data from the firmware storage terminal.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A firmware update method having firmware update troubleshooting mechanism used in an electronic system, comprising:
using partial data comprised in firmware data as test data to perform a test process by a control terminal to transmit the test data to a processing terminal, so as to write the test data to a firmware storage terminal by using a control interface of the processing terminal according to a setting of a plurality of access parameters, read the written test data from the firmware storage terminal through the control interface and compare the written test data and the test data to generate a comparison result;
performing a parameter adjustment process on at least one of the access parameters by the control terminal when the comparison result indicates a mismatching condition;
performing the test process by using the partial data again by the control terminal after the parameter adjustment process finishes being performed, such that the parameter adjustment process is further performed again when the comparison result still indicates the mismatching condition; and
transmitting the firmware data to the processing terminal by the control terminal when the comparison result indicates a matching condition, so as to write the firmware data to the firmware storage terminal by using the control interface according to the setting of the access parameters adjusted by the parameter adjustment process.

2. The firmware update method of claim 1, wherein the access parameters at least comprise a slew rate, a driving ability and a clock frequency, the firmware update method further comprising:
setting the slew rate to be a maximum slew rate, the driving ability to be a minimum driving ability and the clock frequency to be a maximum clock frequency by the control terminal when the test process is performed for the first time; and
performing at least one of decreasing the slew rate, increasing the driving ability and decreasing the clock frequency by the control terminal during the parameter adjustment process.

3. The firmware update method of claim 2, further comprising:
in different times of performance of the parameter adjustment process, decreasing the slew rate step by step first until the slew rate reaches the minimum slew rate, increasing the driving ability step by step subsequently until the driving ability reaches a maximum driving ability and further decreasing the clock frequency step by step until the clock frequency reaches a minimum clock frequency by the control terminal;
wherein when the slew rate reaches the minimum slew rate, the driving ability reaches the maximum driving ability and the clock frequency reaches the minimum clock frequency, the control terminal determines that the access parameters are not able to be further adjusted.

4. The firmware update method of claim 1, further comprising:
using the firmware data as the test data to perform the test process by the control terminal to generate a firmware comparison result when the comparison result generated by using the partial data as the test data to perform the test process indicates the matching condition;
performing the parameter adjustment process on at least one of the access parameters by the control terminal when the firmware comparison result indicates the mismatching condition;
performing the test process by using the firmware data again by the control terminal after the parameter adjustment process finishes being performed, such that the parameter adjustment process is further performed again when the firmware comparison result still indicates the mismatching condition; and
storing the access parameters to a parameter storage circuit when the firmware comparison result indicates the matching condition.

5. The firmware update method of claim 4, further comprising:
determining that the firmware data fails to be updated to the firmware storage terminal by the control terminal when the control terminal determines that the access parameters are not able to be further adjusted and when the comparison result still indicates the mismatching condition.

6. The firmware update method of claim 4, further comprising:
performing an activation process by the processing terminal to read the access parameters from the parameter storage circuit to configure the control interface and read the firmware data from the firmware storage terminal according to the access parameters through the control interface to further perform the subsequent activation process.

7. The firmware update method of claim 4, wherein the parameter storage circuit is a one-time programming memory (OTP ROM) or an eFuse comprised by the processing terminal, or configured to be a part of the firmware storage terminal.

8. The firmware update method of claim 1, further comprising:
writing the access parameters to a plurality of access registers related to the control interface by the processing terminal to configure the control interface so as to access the firmware storage terminal.

9. The firmware update method of claim 1, wherein the test process further comprises:
performing erasing on the firmware storage terminal through the control interface by the control terminal;
loading the test data to a data storage circuit further comprised by the processing terminal by the control terminal;
writing the test data from the data storage circuit to the firmware storage terminal through the control interface by the control terminal; and
reading the firmware storage terminal through the control interface to perform comparison on read data and the test data to generate the comparison result by the control terminal.

10. The firmware update method of claim 1, wherein the firmware storage terminal is a flash memory or an erasable programmable read only memory (EPROM), the control interface is a serial peripheral interface (SPI) or a I²C interface.

11. An electronic system having firmware update troubleshooting mechanism, comprising:
a firmware storage terminal;
a processing terminal comprising a control interface; and
a control terminal, configured to execute a burning program, to further execute a firmware update method comprising:
using partial data comprised in firmware data as test data to perform a test process by the control terminal to transmit the test data to the processing terminal, so as to write the test data to the firmware storage terminal by using the control interface of the processing terminal according to a setting of a plurality of access parameters, read the written test data from the firmware storage terminal through the control interface and compare the written test data and the test data to generate a comparison result;
performing a parameter adjustment process on at least one of the access parameters by the control terminal when the comparison result indicates a mismatching condition;
performing the test process by using the partial data again by the control terminal after the parameter adjustment process finishes being performed, such that the parameter adjustment process is further performed again when the comparison result still indicates the mismatching condition; and
transmitting the firmware data to the processing terminal by the control terminal when the comparison result indicates a matching condition, so as to write the firmware data to the firmware storage terminal by using the control interface according to the setting of the access parameters adjusted by the parameter adjustment process.

12. The electronic system of claim 11, wherein the access parameters at least comprise a slew rate, a driving ability and a clock frequency, the firmware update method further comprising:
setting the slew rate to be a maximum slew rate, the driving ability to be a minimum driving ability and the clock frequency to be a maximum clock frequency by the control terminal when the test process is performed for the first time; and
performing at least one of decreasing the slew rate, increasing the driving ability and decreasing the clock frequency by the control terminal during the parameter adjustment process.

13. The electronic system of claim 12, wherein the firmware update method further comprises:
in different times of performance of the parameter adjustment process, decreasing the slew rate step by step first until the slew rate reaches the minimum slew rate, increasing the driving ability step by step subsequently until the driving ability reaches a maximum driving ability and further decreasing the clock frequency step by step until the clock frequency reaches a minimum clock frequency by the control terminal;
wherein when the slew rate reaches the minimum slew rate, the driving ability reaches the maximum driving ability and the clock frequency reaches the minimum clock frequency, the control terminal determines that the access parameters are not able to be further adjusted.

14. The electronic system of claim 11, wherein the firmware update method further comprises:
using the firmware data as the test data to perform the test process by the control terminal to generate a firmware comparison result when the comparison result generated by using the partial data as the test data to perform the test process indicates the matching condition;
performing the parameter adjustment process on at least one of the access parameters by the control terminal when the firmware comparison result indicates the mismatching condition;
performing the test process by using the firmware data again by the control terminal after the parameter adjustment process finishes being performed, such that the parameter adjustment process is further performed again when the firmware comparison result still indicates the mismatching condition; and
storing the access parameters to a parameter storage circuit when the firmware comparison result indicates the matching condition.

15. The electronic system of claim 14, wherein the firmware update method further comprises:
determining that the firmware data fails to be updated to the firmware storage terminal by the control terminal when the control terminal determines that the access parameters are not able to be further adjusted and when the comparison result still indicates the mismatching condition.

16. The electronic system of claim 14, wherein the firmware update method further comprises:
performing an activation process by the processing terminal to read the access parameters from the parameter storage circuit to configure the control interface and read the firmware data from the firmware storage terminal according to the access parameters through the control interface to further perform the subsequent activation process.

17. The electronic system of claim 14, wherein the parameter storage circuit is a one-time programming memory (OTP ROM) or an eFuse comprised by the processing terminal, or configured to be a part of the firmware storage terminal.

18. The electronic system of claim 11, wherein the firmware update method further comprises:
writing the access parameters to a plurality of access registers related to the control interface by the processing terminal to configure the control interface so as to access the firmware storage terminal.

19. The electronic system of claim 11, wherein the test process further comprises:
performing erasing on the firmware storage terminal through the control interface by the control terminal;
loading the test data to a data storage circuit further comprised by the processing terminal by the control terminal;
writing the test data from the data storage circuit to the firmware storage terminal through the control interface by the control terminal; and
reading the firmware storage terminal through the control interface to perform comparison on read data and the test data to generate the comparison result by the control terminal.

20. The electronic system of claim 11, wherein the firmware storage terminal is a flash memory or an erasable programmable read only memory, the control interface is a serial peripheral interface or a I²C interface.
